(19) United States
(12) Patent Application Publication
(10) Pub. No.: US 2025/0131689 A1
(43) Pub. Date: Apr. 24, 2025

(54) IMAGE PROCESSING APPARATUS, IMAGE PROCESSING METHOD, AND NON-TRANSITORY STORAGE MEDIUM

(71) Applicant: NEC Corporation, Minato- ku, Tokyo (JP)

(72) Inventors: Ryo KAWAI, Tokyo (JP); Noboru YOSHIDA, Tokyo (JP); Jianquan LIU, Tokyo (JP)

(73) Assignee: NEC Corporation, Minato- ku, Tokyo (JP)

(21) Appl. No.: 18/834,431

(22) PCT Filed: Feb. 14, 2022
(86) PCT No.: PCT/JP2022/005695

§ 371 Date: Jul. 30, 2024

(51) Int. Cl. G06V 10/74; G06T 7/246; G06T 7/73; G06V 10/75; G06V 40/10

(52) U.S. Cl. CPC G06V 10/761; G06T 7/248; G06T 7/74; G06V 10/751; G06V 40/10; G06T 2207/10016; G06T 2207/30196

(57) ABSTRACT

The present invention provides an image processing apparatus (10) detects a keypoint of a human body included in an image; computes a degree of similarity between a pose or a movement of a human body detected from the image and a pose or a movement of a human body indicated by a preregistered template image, based on the detected keypoint; determines a place in the image where a human body also with the degree of similarity to a pose or a movement of a human body indicated by any template image to be less than a first threshold value but satisfying a first similarity condition to a pose or a movement of a human body indicated by any template image is captured; and outputs information indicating the determined place or a partial image acquired by cutting the place out of the image.

### TECHNICAL FIELD

The present invention relates to an image processing apparatus, an image processing method, and a program.

### BACKGROUND ART

A technique related to the present invention is disclosed in Patent Documents 1 to 3 and Non-Patent Document 1.

Patent Document 1 discloses a technique for computing a feature value of each of a plurality of keypoints of a human body included in an image, searching for an image including a human body with a similar pose and a human body with a similar movement, based on the computed feature value, and putting together the similar poses and the similar movements and classifying. Further, Non-Patent Document 1 discloses a technique related to skeleton estimation of a person.

Patent Document 2 discloses a technique for performing learning of a discriminator that classifies, after a plurality of images in which a predetermined area is captured and information indicating a change in a situation of the predetermined area are acquired, the plurality of images, based on the information indicating the change in the situation of the predetermined area, and decides the situation of the predetermined area from the image by using at least a part of the plurality of images.

Patent Document 3 discloses a technique for detecting a state change of a target in a person, based on an input image, and deciding an abnormal state in response to detection of occurrence of the state change of the target in a plurality of people.

### Related Document

### Patent Document

Patent Document 1: International Patent Publication No. WO2021/084677
Patent Document 2: Japanese Patent Application Publication No. 2021-87031
Patent Document 3: International Patent Publication No. WO2015/198767

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299

### DISCLOSURE OF THE INVENTION

### Technical Problem

According to the technique disclosed in Patent Document 1 described above, a human body with a desired pose and a desired movement can be detected from an image being a processing target by preregistering, as a template image, an image including a human body with a desired pose and a desired movement. As a result of discussing such a technique disclosed in Patent Document 1, the present inventor has newly found out that a human body with a desired pose and a desired movement can be detected without an omission by newly and additionally registering, as a template image, an image including a human body with a variety of poses and movements that are not decided to be the same or the same kind as a pose and a movement indicated by a registered template image but that are similar. Then, the present inventor has newly found out that there is room for improvement in workability of work for finding an image including a human body with a variety of poses and movements that are not decided to be the same or the same kind as a pose or a movement indicated by such a registered template image but that are similar.

All of Patent Documents 1 to 3 and Non-Patent Document 1 described above do not disclose a problem related to a template image and a solution to the problem, and thus have a problem that the problem described above cannot be solved.

One example of an object of the present invention is, in view of the problem described above, to provide an image processing apparatus, an image processing method, and a program that solve a problem of workability of work for registering, as a template image, an image including a human body with a variety of poses and movements that are not decided to be the same or the same kind as a pose and a movement indicated by a registered template image but that are similar.

### Solution to Problem

One aspect of the present invention provides an image processing apparatus including:
a skeleton structure detection unit that performs processing of detecting a keypoint of a human body included in an image;
a similarity degree computation unit that computes a degree of similarity between a pose or a movement of a human body detected from the image and a pose or a movement of a human body indicated by a preregistered template image, based on the detected keypoint;
a determination unit that determines a place in the image where a human body also with the degree of similarity to a pose or a movement of a human body indicated by any template image to be less than a first threshold value but satisfying a first similarity condition to a pose or a movement of a human body indicated by any template image is captured; and
an output unit that outputs information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.

Further, one aspect of the present invention provides an image processing method including,
by a computer:
performing processing of detecting a keypoint of a human body included in an image;
computing a degree of similarity between a pose or a movement of a human body detected from the image and a pose or a movement of a human body indicated by a preregistered template image, based on the detected keypoint;
determining a place in the image where a human body also with the degree of similarity to a pose or a movement of a human body indicated by any template image to be less than a first threshold value but satisfying a first similarity condition to a pose or a movement of a human body indicated by any template image is captured; and
outputting information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.

Further, one aspect of the present invention provides a program causing a computer to function as:
a skeleton structure detection unit that performs processing of detecting a keypoint of a human body included in an image;
a similarity degree computation unit that computes a degree of similarity between a pose or a movement of a human body detected from the image and a pose or a movement of a human body indicated by a preregistered template image, based on the detected keypoint;
a determination unit that determines a place in the image where a human body also with the degree of similarity to a pose or a movement of a human body indicated by any template image to be less than a first threshold value but satisfying a first similarity condition to a pose or a movement of a human body indicated by any template image is captured; and
an output unit that outputs information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.

### Advantageous Effects of Invention

According to one aspect of the present invention, an image processing apparatus, an image processing method, and a program that solve a problem of workability of work for registering, as a template image, an image including a human body with a variety of poses and movements that are not decided to be the same or the same kind as a pose and a movement indicated by a registered template image but that are similar are acquired.

### BRIEF DESCRIPTION OF THE DRAWINGS

The above-described object, the other objects, features, and advantages will become more apparent from suitable example embodiment described below and the following accompanying drawings.

FIG. 1 It is a diagram illustrating one example of a functional block diagram of an image processing apparatus.

FIG. 2 It is a diagram illustrating a processing content of the image processing apparatus.

FIG. 3 It is a diagram illustrating one example of a hardware configuration of the image processing apparatus.

FIG. 4 It is a diagram illustrating one example of a skeleton structure of a human model detected by the image processing apparatus.

FIG. 5 It is a diagram illustrating one example of a skeleton structure of a human model detected by the image processing apparatus.

FIG. 6 It is a diagram illustrating one example of a skeleton structure of a human model detected by the image processing apparatus.

FIG. 7 It is a diagram illustrating one example of a skeleton structure of a human model detected by the image processing apparatus.

FIG. 8 It is a diagram illustrating one example of a feature value of a keypoint computed by the image processing apparatus.

FIG. 9 It is a diagram illustrating one example of a feature value of a keypoint computed by the image processing apparatus.

FIG. 10 It is a diagram illustrating one example of a feature value of a keypoint computed by the image processing apparatus.

FIG. 11 It is a diagram schematically illustrating one example of information output from the image processing apparatus.

FIG. 12 It is a flowchart illustrating one example of a flow of processing of the image processing apparatus.

### EXAMPLE EMBODIMENT

Hereinafter, example embodiments of the present invention will be described with reference to the drawings. Note that, in all of the drawings, a similar component has a similar reference sign, and description thereof will be appropriately omitted.

### First Example Embodiment

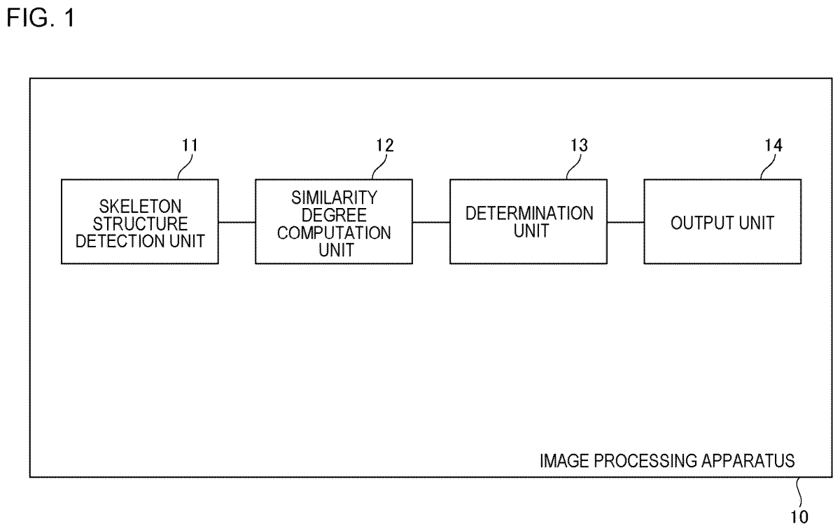

FIG. 1 is a functional block diagram illustrating an overview of an image processing apparatus 10 according to a first example embodiment. As illustrated in FIG. 1, the image processing apparatus 10 includes a skeleton structure detection unit 11, a similarity degree computation unit 12, a determination unit 13, and an output unit 14.

The skeleton structure detection unit 11 performs processing of detecting a keypoint of a human body included in an image. The similarity degree computation unit 12 computes a degree of similarity between a pose or a movement of a human body detected from the image and a pose or a movement of a human body indicated by a preregistered template image, based on the detected keypoint. The determination unit 13 determines a place in the image where a human body also with the degree of similarity to a pose or a movement of a human body indicated by any template image to be less than a first threshold value and satisfying a first similarity condition to a pose or a movement of a human body indicated by any template image is captured. The output unit 14 outputs information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.

The image processing apparatus 10 can solve a problem of workability of work for registering, as a template image, an image including a human body with a variety of poses and movements that are not decided to be the same or the same kind as a pose or a movement indicated by a registered template image but that are similar.

### Second Example Embodiment

### Overview

An image processing apparatus 10 computes a degree of similarity between a pose or a movement of a human body included in an image (hereinafter simply referred to as an “image”) being an original of a template image and a pose or a movement of a human body indicated by a preregistered template image, and then determines a place in the image where a human body also with the degree of similarity to a pose or a movement of a human body indicated by any template image to be less than a first threshold value but satisfying a first similarity condition to the pose or the movement of the human body indicated by any template image is captured. Then, the image processing apparatus 10 outputs information indicating the determined place or a partial image acquired by cutting the determined place out of the image, as a candidate for the template image to be additionally registered in a decision apparatus. The decision apparatus performs detection processing using a registered template image, and the like, and, in a case where the above-described degree of similarity is equal to or more than the first threshold value, the decision apparatus decides that the pose or the movement of the human body detected from the image is the same or the same kind as the pose or the movement of the human body indicated by the template image.

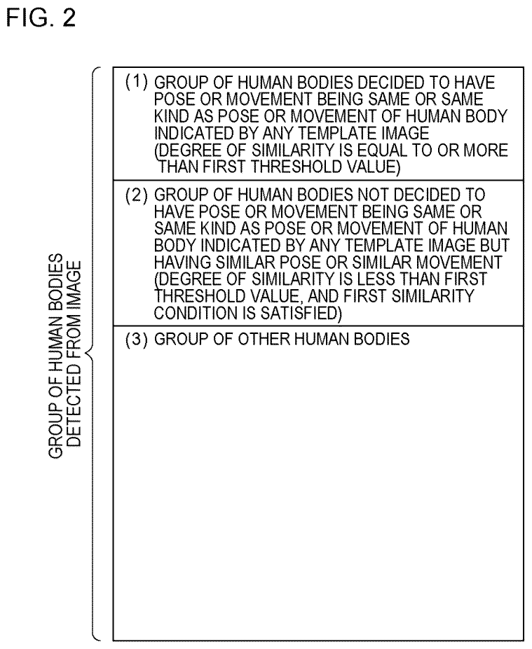

Such an image processing apparatus 10 can determine a place in an image where, in a group of human bodies detected from the image, a human body not decided to have a pose or a movement being the same or the same kind as a pose or a movement of a human body indicated by any template image but with a similar pose or a similar movement is captured, and can output information about the determined place. Description is given in more detail by using FIG. 2.

In the second example embodiment, as illustrated in FIG. 2, a group of human bodies detected from an image is classified into (1) a group of human bodies decided to have a pose or a movement being the same or the same kind as a pose or a movement of a human body indicated by any template image, (2) a group of human bodies decided not to have a pose or a movement being the same or the same kind as a pose or a movement of a human body indicated by any template image but with a similar pose or a similar movement, and (3) a group of other human bodies. (3) The group of other human bodies is a group of human bodies not decided to have a pose or a movement being the same or the same kind as a pose or a movement of a human body indicated by any template image and with a dissimilar pose or a dissimilar movement. In the present example embodiment, a place in an image where a human body included in (2) the group of human bodies that are not decided to have a pose or a movement being the same or the same kind as a pose or a movement of a human body indicated by any template image but that have a similar pose or a similar movement is captured is determined, and information about the determined place is output. Details will be described below.

### Hardware Configuration

Next, one example of a hardware configuration of the image processing apparatus 10 will be described. Each functional unit of the image processing apparatus 10 is achieved by any combination of hardware and software concentrating on a central processing unit (CPU) of any computer, a memory, a program loaded into the memory, a storage unit (that can also store a program downloaded from a storage medium such as a compact disc (CD), a server on the Internet, and the like in addition to a program previously stored at a stage of shipping of an apparatus) such as a hard disk that stores the program, and a network connection interface. Then, various modification examples of an achievement method and an apparatus thereof are understood by a person skilled in the art.

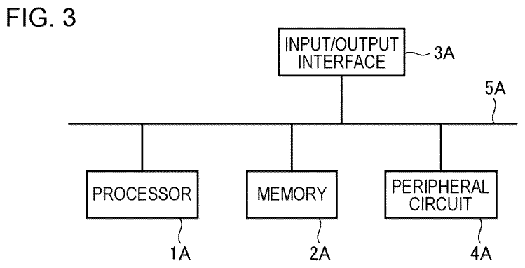

FIG. 3 is a block diagram illustrating a hardware configuration of the image processing apparatus 10. As illustrated in FIG. 3, the image processing apparatus 10 includes a processor 1A, a memory 2A, an input/output interface 3A, a peripheral circuit 4A, and a bus 5A. Various modules are included in the peripheral circuit 4A. The image processing apparatus 10 may not include the peripheral circuit 4A. Note that the image processing apparatus 10 may be formed of a plurality of apparatuses being separated physically and/or logically. In this case, each of the plurality of apparatuses can include the hardware configuration described above.

The bus 5A is a data transmission path for the processor 1A, the memory 2A, the peripheral circuit 4A, and the input/output interface 3A to transmit and receive data to and from one another. The processor 1A is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can output an instruction to each of modules, and perform an arithmetic operation, based on an arithmetic result of the modules.

### Functional Configuration

FIG. 1 is a functional block diagram illustrating an overview of the image processing apparatus 10 according to a second example embodiment. As illustrated in FIG. 1, the image processing apparatus 10 includes a skeleton structure detection unit 11, a similarity degree computation unit 12, a determination unit 13, and an output unit 14.

The skeleton structure detection unit 11 performs processing of detecting a keypoint of a human body included in an image.

An “image” is an image being an original of a template image. The template image is an image being preregistered in the technique disclosed in Patent Document 1 described above, and is an image including a human body with a desired pose and a desired movement (a pose and a movement desired to be detected by a user). The image may be a moving image formed of a plurality of frame images, and may be a still image formed of one image.

The skeleton structure detection unit 11 detects N (N is an integer of two or more) keypoints of a human body included in an image. In a case where a moving image is a processing target, the skeleton structure detection unit 11 performs processing of detecting a keypoint for each frame image. The processing by the skeleton structure detection unit 11 is achieved by using the technique disclosed in Patent Document 1. Although details will be omitted, in the technique disclosed in Patent Document 1, detection of a skeleton structure is performed by using a skeleton estimation technique such as OpenPose disclosed in Non-Patent Document 1. A skeleton structure detected in the technique is formed of a “keypoint” being a characteristic point such as a joint and a “bone (bone link)” indicating a link between keypoints.

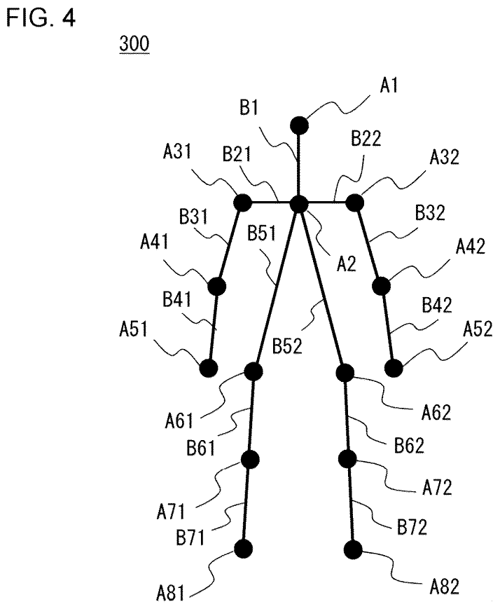

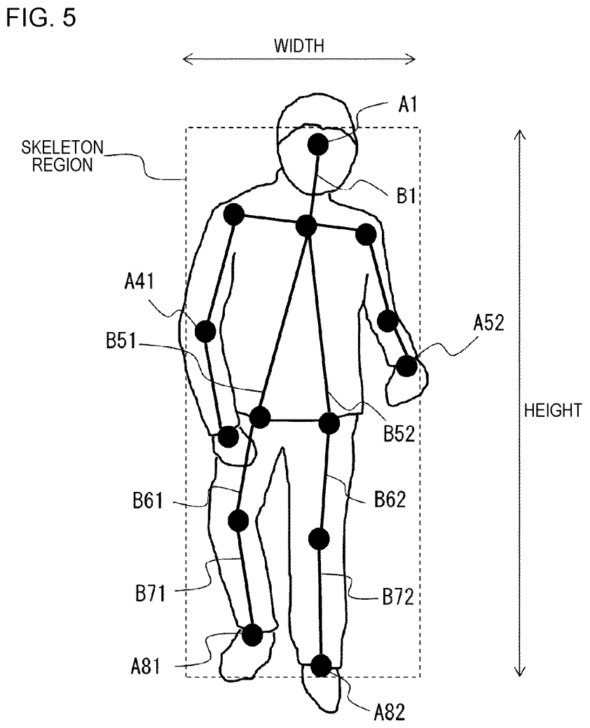

FIG. 4 illustrates a skeleton structure of a human model 300 detected by the skeleton structure detection unit 11. FIGS. 5 to 7 each illustrate a detection example of the skeleton structure. The skeleton structure detection unit 11 detects the skeleton structure of the human model (two-dimensional skeleton model) 300 as in FIG. 4 from a two-dimensional image by using a skeleton estimation technique such as OpenPose. The human model 300 is a two-dimensional model formed of a keypoint such as a joint of a person and a bone connecting keypoints.

For example, the skeleton structure detection unit 11 extracts a feature point that may be a keypoint from an image, refers to information acquired by performing machine learning on the image of the keypoint, and detects N keypoints of a human body. The detected N keypoints are predetermined. There is variety in the number (i.e., the number of N) of detected keypoints and which portion of a human body a keypoint is used to detect, and various variations can be adopted.

Hereinafter, as illustrated in FIG. 4, a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 are assumed to be determined as N keypoints (N=14) of a detection target. Note that, in the human model 300 illustrated in FIG. 3, as a bone of the person connecting the keypoints, a bone B1 connecting the head A1 and the neck A2, a bone B21 connecting the neck A2 and the right shoulder A31, a bone B22 connecting the neck A2 and the left shoulder A32, a bone B31 connecting the right shoulder A31 and the right elbow A41, a bone B32 connecting the left shoulder A32 and the left elbow A42, a bone B41 connecting the right elbow A41 and the right hand A51, a bone B42 connecting the left elbow A42 and the left hand A52, a bone B51 connecting the neck A2 and the right waist A61, a bone B52 connecting the neck A2 and the left waist A62, a bone B61 connecting the right waist A61 and the right knee A71, a bone B62 connecting the left waist A62 and the left knee A72, a bone B71 connecting the right knee A71 and the right foot A81, and a bone B72 connecting the left knee A72 and the left foot A82 are further predetermined.

FIG. 5 is an example of detecting a person in an upright state. In FIG. 5, the upright person is captured from the front, the bone B1, the bone B51 and the bone B52, the bone B61 and the bone B62, and the bone B71 and the bone B72 that are viewed from the front are each detected without overlapping, and the bone B61 and the bone B71 of a right leg are bent slightly more than the bone B62 and the bone B72 of a left leg.

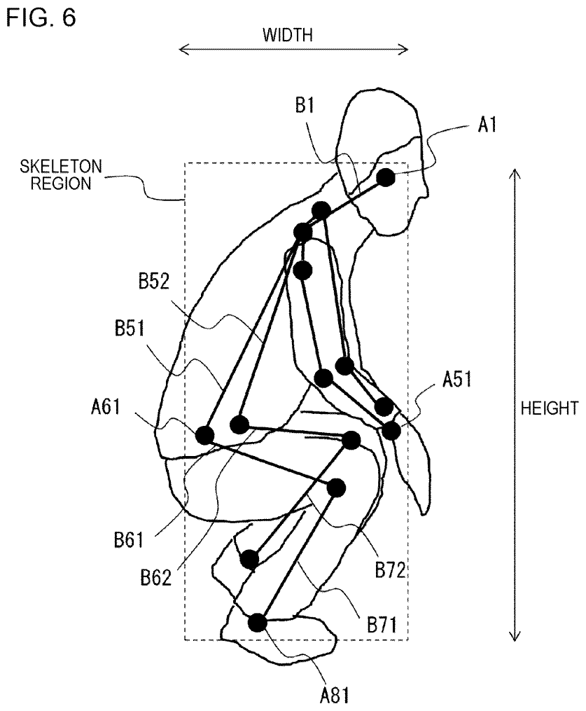

FIG. 6 is an example of detecting a person in a squatting state. In FIG. 6, the squatting person is captured from a right side, the bone B1, the bone B51 and the bone B52, the bone B61 and the bone B62, and the bone B71 and the bone B72 that are viewed from the right side are each detected, and the bone B61 and the bone B71 of a right leg and the bone B62 and the bone B72 of a left leg are greatly bent and also overlap.

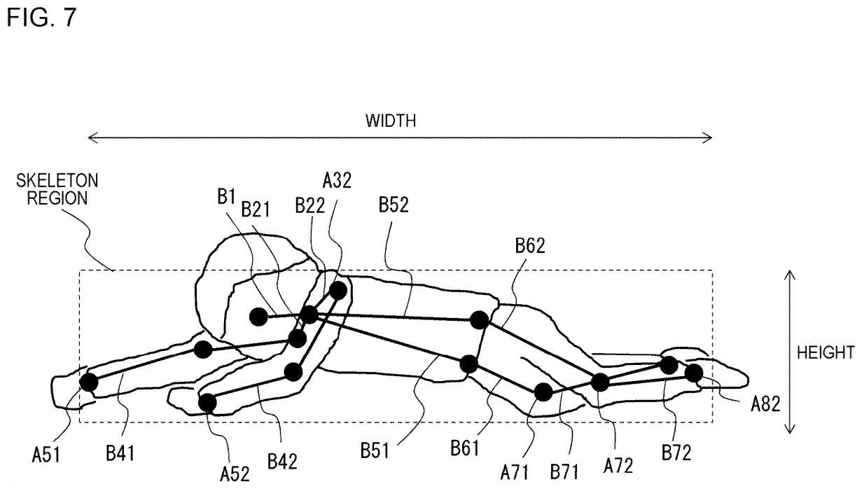

FIG. 7 is an example of detecting a person in a sleeping state. In FIG. 7, the sleeping person is captured diagonally from the front left, the bone B1, the bone B51 and the bone B52, the bone B61 and the bone B62, and the bone B71 and the bone B72 that are viewed diagonally from the front left are each detected, and the bone B61 and the bone B71 of a right leg and the bone B62 and the bone B72 of a left leg are bent and also overlap.

Returning to FIG. 1, the similarity degree computation unit 12 computes a degree of similarity between a pose or a movement of a human body detected from the image and a pose or a movement of a human body indicated by a preregistered template image, based on the keypoint detected by the skeleton structure detection unit 11.

There are various ways of computing a degree of similarity of a pose or a movement of a human body described above, and various techniques can be adopted. For example, the technique disclosed in Patent Document 1 may be adopted. Further, the same technique as the technique of the decision apparatus that computes a degree of similarity between a pose or a movement of a human body indicated by a template image and a pose or a movement of a human body detected from an image, and detects a human body with the degree of similarity equal to or more than a first threshold value as a human body with a pose or a movement being the same or the same kind as the human body indicated by the template image may be adopted. Hereinafter, one example will be described, which is not limited thereto.

As one example, by computing a feature value of a skeleton structure indicated by a detected keypoint, and computing a degree of similarity between a feature value of a skeleton structure of a human body detected from an image and a feature value of a skeleton structure of a human body indicated by a template image, the similarity degree computation unit 12 may compute a degree of similarity between poses of the two human bodies.

The feature value of the skeleton structure indicates a feature of a skeleton of a person, and is an element for classifying a state (a pose and a movement) of the person, based on the skeleton of the person. This feature value normally includes a plurality of parameters. Then, the feature value may be a feature value of the entire skeleton structure, may be a feature value of a part of the skeleton structure, or may include a plurality of feature values as in each portion of the skeleton structure. A method for computing a feature value may be any method such as machine learning and normalization, and a minimum value and a maximum value may be acquired as normalization. As one example, the feature value is a feature value acquired by performing machine learning on the skeleton structure, a size of the skeleton structure from a head to a foot on an image, a relative positional relationship among a plurality of keypoints in an up-down direction in a skeleton region including the skeleton structure on the image, a relative positional relationship among a plurality of keypoints in the left-right direction in the skeleton structure, an and the like. The size of the skeleton structure is a height in the up-down direction, an area, and the like of a skeleton region including the skeleton structure on an image. The up-down direction (a height direction or a vertical direction) is a direction (Y-axis direction) of up and down in an image, and is, for example, a direction perpendicular to the ground (reference surface). Further, the left-right direction (a horizontal direction) is a direction (X-axis direction) of left and right in an image, and is, for example, a direction parallel to the ground.

Note that, in order to perform classification desired by a user, a feature value with robustness with respect to decision processing is preferably used. For example, in a case where a user desires decision that does not depend on an orientation and a body shape of a person, a feature value that is robust with respect to the orientation and the body shape of the person may be used. A feature value that does not depend on an orientation and a body shape of a person can be acquired by learning skeletons of persons facing in various directions with the same pose and skeletons of persons with various body shapes with the same pose, and extracting a feature only in the up-down direction of a skeleton. One example of the processing of computing a feature value of a skeleton structure is disclosed in Patent Document 1.

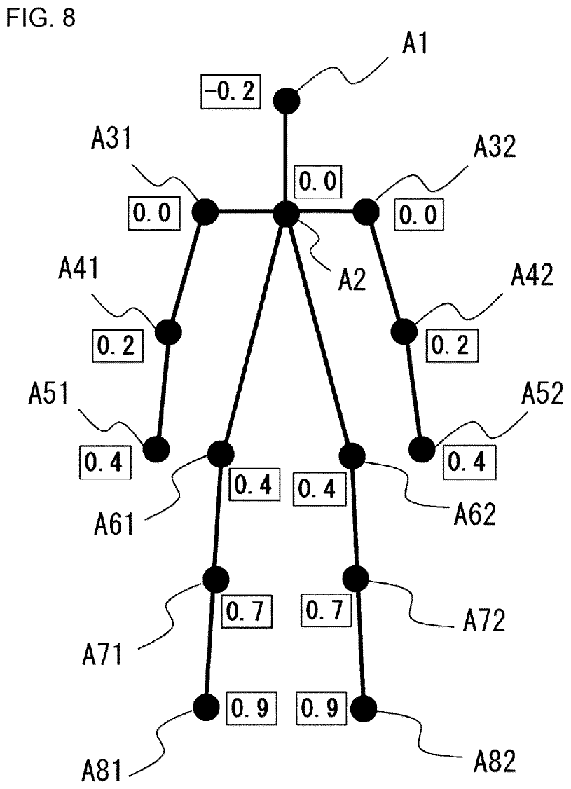

FIG. 8 illustrates an example of a feature value of each of a plurality of keypoints obtained by the similarity degree computation unit 12. A set of feature values of the plurality of keypoints is a feature value of a skeleton structure. Note that, a feature value of a keypoint illustrated herein is merely one example, which is not limited thereto.

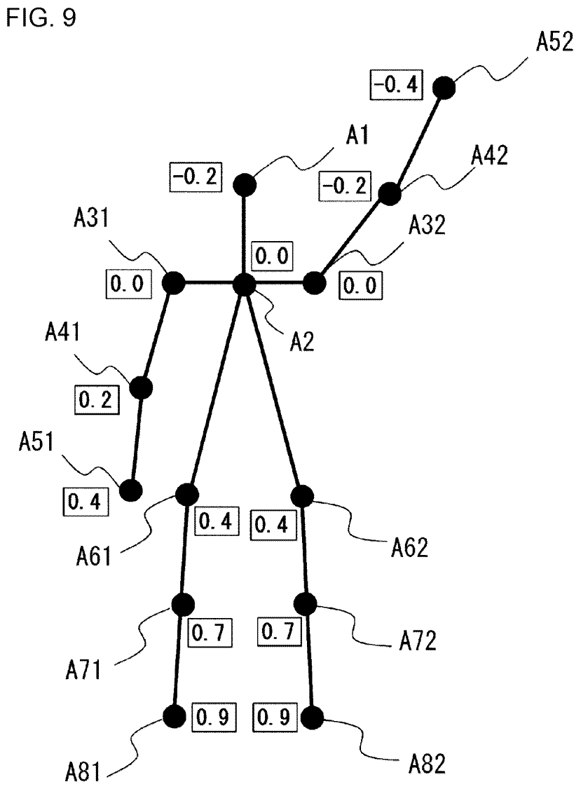

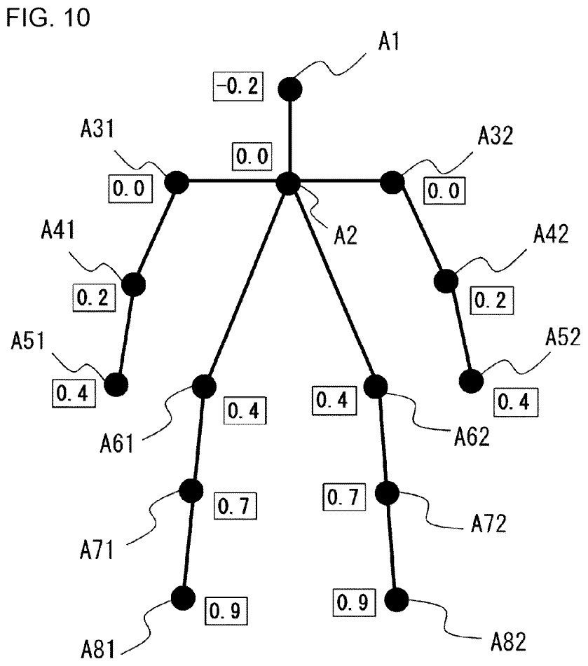

In this example, the feature value of the keypoint indicates a relative positional relationship among a plurality of keypoints in the up-down direction in a skeleton region including a skeleton structure on an image. Since the key point A2 of the neck is the reference point, a feature value of the key point A2 is 0.0 and a feature value of a key point A31 of a right shoulder and a key point A32 of a left shoulder at the same height as the neck is also 0.0. A feature value of a key point Al of a head higher than the neck is −0.2. A feature value of a key point A51 of a right hand and a key point A52 of a left hand lower than the neck is 0.4, and a feature value of the key point A81 of the right foot and the key point A82 of the left foot is 0.9. In a case where the person raises the left hand from this state, the left hand is higher than the reference point as in FIG. 9, and thus a feature value of the key point A52 of the left hand is −0.4. Meanwhile, since normalization is performed by using only a coordinate of the Y axis, as in FIG. 10, a feature value does not change as compared to FIG. 8 even though a width of the skeleton structure changes. In other words, a feature value (normalization value) in the example indicates a feature of a skeleton structure (key point) in the height direction (Y direction), and is not affected by a change of the skeleton structure in the horizontal direction (X direction).

There are various ways of computing a degree of similarity of a pose indicated by such a feature value. For example, after a degree of similarity between feature values is computed for each keypoint, a degree of similarity between poses may be computed based on the degree of similarity between the feature values of the plurality of keypoints. For example, an average value, a maximum value, a minimum value, a mode, a medium value, a weighted average value, a weighted sum, and the like of a degree of similarity between feature values of a plurality of keypoints may be computed as a degree of similarity between poses. In a case where a weighted average value and a weighted sum are computed, a weight of each keypoint may be able to be set by a user, or may be predetermined.

Further, a movement is represented as a time change in a plurality of poses. Thus, for example, the similarity degree computation unit 12 may compute a degree of similarity of a pose by the above-described technique for each combination of a plurality of frame images associated with each other, and then compute, as a degree of similarity of a movement, a statistic (such as an average value, a maximum value, a minimum value, a mode, a medium value, a weighted average value, and a weighted sum) of the degree of similarity of the pose computed for each combination of the plurality of frame images.

Returning to FIG. 1, the determination unit 13 determines, as a candidate for a template image to be additionally registered in the decision apparatus, a place in the image where a human body also with the degree of similarity to a pose or a movement of a human body indicated by any template image to be less than a first threshold value and satisfying a first similarity condition to a pose or a movement of a human body indicated by any template image is captured.

First, processing of determining a human body (human body belonging to the groups of (2) and (3) in FIG. 2) also with a degree of similarity to a pose or a movement of a human body indicated by any template image to be less than a first threshold value will be described.

The determination unit 13 compares a degree of similarity between a pose or a movement of a human body detected from an image and a pose or a movement of a human body indicated by each of a plurality of template images with a first threshold value. Then, the determination unit 13 determines a human body also with the degree of similarity to a pose or a movement of a human body indicated by any template image to be less than the first threshold value, based on a result of the comparison.

Note that, the decision apparatus decides a pose or a movement of a human body detected from an image, based on a pose or a movement of a human body indicated by a template image. Specifically, in a case where the above-described degree of similarity is equal to or more than the first threshold value, the decision apparatus decides that the pose or the movement of the human body detected from the image is the same or the same kind as the pose or the movement of the human body indicated by the template image. In other words, the above-described processing by the determination unit 13 determines a place in an image where, in a group of human bodies detected from the image, a human body not decided by the decision apparatus to have a pose or a movement being the same or the same kind as a pose or a movement of a human body indicated by any template image is captured.

Next, processing of determining a place in an image where a human body (human body belonging to the group of (2) in FIG. 2) satisfying a first similarity condition to a pose or a movement of a human body indicated by any template image is captured will be described.

The determination unit 13 determines a human body belonging to the groups of (2) and (3) in FIG. 2 from among human bodies detected from an image, and then determines, for each determined human body, whether the first similarity condition to a pose or a movement of a human body indicated by any template image is satisfied. Then, the determination unit 13 determines a human body (human body belonging to the group of (2) in FIG. 2) satisfying the first similarity condition to the pose or the movement of the human body indicated by any template image, based on a result of the decision, and also determines a place in the image where the determined human body is captured. A human body not satisfying the first similarity condition is a human body belonging to the group of (3) in FIG. 2.

The first similarity condition includes at least one of
“a degree of similarity to a pose or a movement of a human body indicated by a template image is equal to or more than a second threshold value and is less than a first threshold value”,
“a degree of similarity to a pose or a movement of a human body indicated by a template image computed based on a part of keypoints among a plurality of keypoints (N keypoints) detected from each human body is equal to or more than a third threshold value”,
“a degree of similarity to a pose or a movement of a human body indicated by a template image computed in consideration of a weighted value provided to each of a plurality of keypoints detected from each human body is equal to or more than a fourth threshold value”, and
“including a plurality of frame images indicating each human body with a pose in which a degree of similarity to a pose of a human body indicated by each of frame images in a predetermined proportion or more among a plurality of frame images included in a template image being a moving image is equal to or more than a fifth threshold value”.

In a case where the plurality of exemplified conditions described above are included, the first similarity condition can have a content in which the plurality of conditions are connected by a logical operator such as “or”. Hereinafter, each of the exemplified conditions described above will be described.

“A degree of similarity to a pose or a movement of a human body indicated by a template image is equal to or more than a second threshold value and is less than a first threshold value.”

A “degree of similarity” of the condition is a value computed by the same method as the computation method by the similarity degree computation unit 12 described above. Then, the second threshold value is a value smaller than the first threshold value.

By appropriately setting the second threshold value, a human body (human body belonging to the group of (2) in FIG. 2) not decided to have a pose or a movement being the same or the same kind as a pose or a movement of a human body indicated by any template image but with a similar pose or a similar movement can be detected.

“A degree of similarity to a pose or a movement of a human body indicated by a template image computed based on a part of keypoints among a plurality of keypoints (N keypoints) detected from each human body is equal to or more than a third threshold value”,
A “degree of similarity” of the condition is a value computed based on a part of keypoints among a plurality of keypoints (N keypoints) being a detection target. The degree of similarity of the condition can be computed by adopting the same method as the computation method by the similarity degree computation unit 12 described above except for a point of using only a feature value of a part of keypoints among a plurality of keypoints (N keypoints).

Whether to use any keypoint is a design manner, but may be able to be specified by a user, for example. The user can specify a keypoint of a body portion (for example, an upper body) to be seriously considered, and remove a keypoint of a body portion (for example, a lower body) not to be seriously considered from specification.

By appropriately setting the third threshold value, a human body (human body belonging to the group of (2) in FIG. 2) not decided to have a pose or a movement being the same or the same kind as a pose or a movement of a human body indicated by any template image but with a part of the body with the same or similar pose or movement can be detected.

“A degree of similarity to a pose or a movement of a human body indicated by a template image computed in consideration of a weighted value provided to each of a plurality of keypoints detected from each human body is equal to or more than a fourth threshold value.”

A “degree of similarity” of the condition is a value computed by providing a weight to a plurality of keypoints (N keypoints) being a detection target. For example, after a degree of similarity between feature values is computed for each keypoint by adopting the same method as the computation method by the similarity degree computation unit 12 described above, a weighted average value or a weighted sum of the degree of similarity between the feature values of the plurality of keypoints is computed as a degree of similarity between poses by using the above-described weighted value. A weight of each keypoint may be able to be set by a user, or may be predetermined.

By appropriately setting the fourth threshold value, a human body (human body belonging to the group of (2) in FIG. 2) not decided to have a pose or a movement being the same or the same kind as a pose or a movement of a human body indicated by any template image but with the same or similar pose or movement in a case where a part of the body is weighted can be detected.

“Including a plurality of frame images indicating each human body with a pose in which a degree of similarity to a pose of a human body indicated by each of frame images in a predetermined proportion or more among a plurality of frame images included in a template image being a moving image is equal to or more than a fifth threshold value.”

The condition is used in a case where an image and a template image are a moving image, and a movement of a human body is indicated by a time change in a pose of the human body indicated by each of the plurality of template images included in the moving image.

For example, a template image is formed of M frame images, and a plurality of frame images including each human body with a pose similar to, at a predetermined level or higher (with a degree of similarity equal to or more than the fifth threshold value), a pose of a human body indicated by each of frame images in a predetermined proportion or more (for example, 70 percent or more) among the M frame images satisfy the condition. As a technique for computing a degree of similarity between poses for each combination of a plurality of frame images associated with each other, the same method as the computation method by the similarity degree computation unit 12 described above can be adopted.

By appropriately setting the fifth threshold value and the predetermined proportion, a human body (human body belonging to the group of (2) in FIG. 2) not decided to have a pose or a movement being the same or the same kind as a movement of a human body indicated by any template image but with a movement being same as or similar to a movement of a human body in a part of a time period in the template image (moving image) can be detected.

Note that, in a case where an image is a still image, a “place determined by the determination unit 13” is a partial region in one still image. In this case, for each still image, the above-described place is indicated by, for example, coordinates in a coordinate system set in the still image. On the other hand, in a case where an image is a moving image, a “place determined by the determination unit 13” is a partial region in each frame image being a part of a plurality of frame images in the moving image. In this case, for each moving image, the above-described place is indicated by, for example, information (such as frame identification information and an elapsed time from the beginning) indicating the frame image being a part of the plurality of frame images, and coordinates in a coordinate system set in the frame image.

The output unit 14 outputs information indicating the place determined by the determination unit 13 or a partial image acquired by cutting, out of the image, the place determined by the determination unit 13, as a candidate for the template image to be additionally registered in the decision apparatus. Note that, in a case where the output unit 14 outputs a partial image, the image processing apparatus 10 can include a processing unit that generates a partial image by cutting, out of an image, a place determined by the determination unit 13. Then, the output unit 14 can output the partial image generated by the processing unit.

A “place determined by the determination unit 13” described above, i.e., a place in the image where a human body also with the degree of similarity to a pose or a movement of a human body indicated by any template image to be less than a first threshold value and satisfying a first similarity condition to a pose or a movement of a human body indicated by any template image is captured is a candidate for the template image. A user can select, as the template image, a place including a human body with a desired pose and a desired movement from the candidates by viewing the above-described place, based on the above-described information or the above-described partial image, and the like.

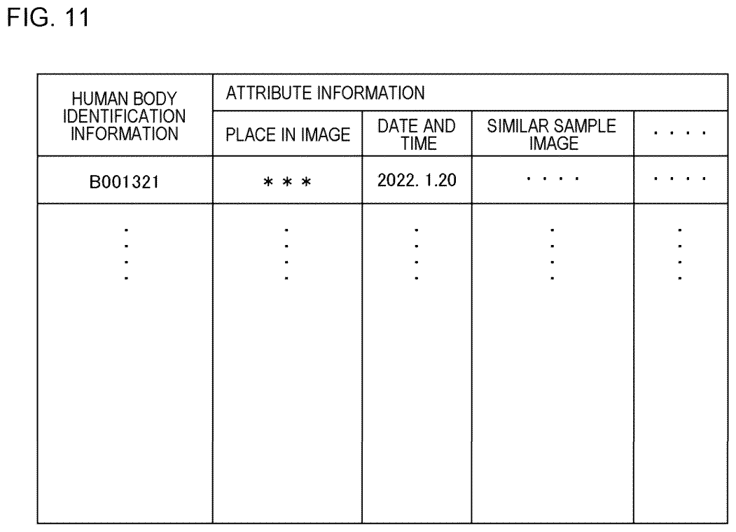

FIG. 11 schematically illustrates one example of information output from the output unit 14. In the example illustrated in FIG. 11, human body identification information for identifying a plurality of detected human bodies from each other, attribute information about each of the human bodies, and a similar sample image are associated with one another. Then, as one example of the attribute information, information indicating a place in an image (information indicating a place where the human body described above is captured), and a date and time of capturing of the image are displayed. In addition, the attribute information may include information (for example: rear in Bus No. 102, an entrance of ○○ Park, and the like) indicating an installation position (capturing position) of a camera that captures the image, and attribute information (for example: gender, an age group, a body type, and the like) about a person computed by an image analysis.

In a column of the similar sample image, information (such as a file name of an image) indicating a template image satisfying a first similarity condition to each human body is entered. In this way, the output unit 14 can further output information indicating a template image satisfying the first similarity condition to a human body captured at a place determined by the determination unit 13.

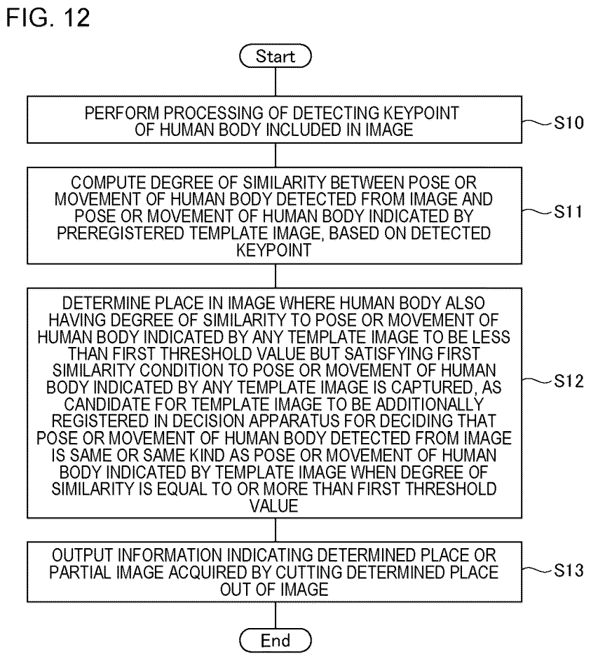

Next, one example of a flow of processing of the image processing apparatus 10 will be described by using a flowchart in FIG. 12.

After the image processing apparatus 10 performs processing of detecting a keypoint of a human body included in an image (S10), the image processing apparatus 10 computes a degree of similarity between a pose or a movement of a human body detected from the image and a pose or a movement of a human body indicated by a preregistered template image, based on the detected keypoint (S11).

Next, the image processing apparatus 10 determines, as a candidate for the template image to be additionally registered in the decision apparatus, a place in the image where a human body also with the degree of similarity to a pose or a movement of a human body indicated by any template image to be less than a first threshold value and satisfying a first similarity condition to a pose or a movement of a human body indicated by any template image is captured (S12).

Specifically, the image processing apparatus 10 compares the degree of similarity between the pose or the movement of the human body detected from the image and the pose or the movement of the human body indicated by each of the plurality of template images with the first threshold value. Then, the image processing apparatus 10 determines the human body (human body belonging to the groups of (2) and (3) in FIG. 2) also with the degree of similarity to the pose or the movement of the human body indicated by any template image to be less than the first threshold value, based on a result of the comparison. Subsequently, the image processing apparatus 10 determines, for each determined human body, whether the first similarity condition to the pose or the movement of the human body indicated by any template image is satisfied. Then, the image processing apparatus 10 determines a human body (human body belonging to the group of (2) in FIG. 2) satisfying the first similarity condition to the pose or the movement of the human body indicated by any template image, based on a result of the decision, and also determines a place in the image where the determined human body is captured.

The decision apparatus performs detection processing using a registered template image, and the like, and, in a case where the above-described degree of similarity is equal to or more than the first threshold value, the decision apparatus decides that the pose or the movement of the human body detected from the image is the same or the same kind as the pose or the movement of the human body indicated by the template image.

Then, the image processing apparatus 10 outputs information indicating the place determined in S12 or a partial image acquired by cutting the place determined in S12 out of the image (S13).

### Advantageous Effect

The image processing apparatus 10 according to the second example embodiment can achieve an advantageous effect similar to that in the first example embodiment. Further, the image processing apparatus 10 according to the second example embodiment can output information about a place in an image where, in a group of human bodies detected from the image, a human body not decided by the decision apparatus to have a pose or a movement being the same or the same kind as a pose or a movement of a human body indicated by any template image but with a similar pose or a similar movement is captured.

Description is given in more detail by using FIG. 2. In the second example embodiment, as illustrated in FIG. 2, a group of human bodies detected from an image is classified into (1) a group of human bodies decided by the decision apparatus to have a pose or a movement being the same or the same kind as a pose or a movement of a human body indicated by any template image, (2) a group of human bodies decided not to have a pose or a movement being the same or the same kind as a pose or a movement of a human body indicated by any template image but with a similar pose or a similar movement, and (3) a group of other human bodies. (3) The group of other human bodies is a group of human bodies not decided to have a pose or a movement being the same or the same kind as a pose or a movement of a human body indicated by any template image and with a dissimilar pose or a dissimilar movement. The image processing apparatus 10 according to the second example embodiment determines a place in an image where a human body included in (2) the group of human bodies that are not decided to have a pose or a movement being the same or the same kind as a pose or a movement of a human body indicated by any template image but that have a similar pose or a similar movement is captured, and outputs information about the determined place. A user can select, as the template image, a place including a human body with a desired pose and a desired movement from the above-described determined place by viewing the determined place, and the like. As a result, a problem of workability of work for registering, as a template image, an image including a human body with a variety of poses and movements that are not decided to be the same or the same kind as a pose or a movement indicated by a registered template image but that are similar is solved.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

A part or the whole of the above-described example embodiment may also be described in supplementary notes below, which is not limited thereto.
1. An image processing apparatus including:
   a skeleton structure detection unit that performs processing of detecting a keypoint of a human body included in an image;
   a similarity degree computation unit that computes a degree of similarity between a pose or a movement of a human body detected from the image and a pose or a movement of a human body indicated by a preregistered template image, based on the detected keypoint;
   a determination unit that determines a place in the image where a human body also with the degree of similarity to a pose or a movement of a human body indicated by any template image to be less than a first threshold value but satisfying a first similarity condition to a pose or a movement of a human body indicated by any template image is captured; and
   an output unit that outputs information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.
2. The image processing apparatus according to supplementary note 1, wherein
   the determination unit determines whether the human body detected from the image satisfies the first similarity condition, based on the detected keypoint.
3. The image processing apparatus according to supplementary note 2, wherein
   the first similarity condition includes a condition that the degree of similarity is equal to or more than a second threshold value and is less than the first threshold value.
4. The image processing apparatus according to supplementary note 2 or 3, wherein
   the first similarity condition includes a condition that the degree of similarity to a pose or a movement of a human body indicated by the template image computed based on a part of the keypoints among the plurality of keypoints detected from each human body is equal to or more than a third threshold value.
5. The image processing apparatus according to any of supplementary notes 2 to 4, wherein
   the first similarity condition includes a condition that the degree of similarity to a pose or a movement of a human body indicated by the template image computed in consideration of a weighted value provided to each of the plurality of keypoints detected from each human body is equal to or more than a fourth threshold value.
6. The image processing apparatus according to any of supplementary notes 2 to 5, wherein
   the image and the template image are a moving image, and a movement of a human body is indicated by a time change in a pose of a human body indicated by each of a plurality of template images included in the moving image, and
   the first similarity condition includes a condition of including a plurality of frame images indicating each human body with a pose in which a degree of similarity to a pose of a human body indicated by each of frame images in a predetermined proportion or more among the plurality of frame images included in the template image is equal to or more than a fifth threshold value.
7. The image processing apparatus according to any of supplementary notes 1 to 6, wherein
   the output unit further outputs information indicating the template image that satisfies the first similarity condition to a human body captured at the determined place.
8. An image processing method including,
   by a computer:
   performing processing of detecting a keypoint of a human body included in an image;
   computing a degree of similarity between a pose or a movement of a human body detected from the image and a pose or a movement of a human body indicated by a preregistered template image, based on the detected keypoint;
   determining a place in the image where a human body also with the degree of similarity to a pose or a movement of a human body indicated by any template image to be less than a first threshold value but satisfying a first similarity condition to a pose or a movement of a human body indicated by any template image is captured; and
   outputting information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.
9. A program causing a computer to function as:
   a skeleton structure detection unit that performs processing of detecting a keypoint of a human body included in an image;
   a similarity degree computation unit that computes a degree of similarity between a pose or a movement of a human body detected from the image and a pose or a movement of a human body indicated by a preregistered template image, based on the detected keypoint;
   a determination unit that determines a place in the image where a human body also with the degree of similarity to a pose or a movement of a human body indicated by any template image to be less than a first threshold value but satisfying a first similarity condition to a pose or a movement of a human body indicated by any template image is captured; and
   an output unit that outputs information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.

### REFERENCE SIGNS LIST

10 Image processing apparatus
11 Skeleton structure detection unit
12 Similarity degree computation unit
13 Determination unit
14 Output unit
1A Processor
2A Memory
3A Input/output I/F
4A Peripheral circuit
5A Bus

What is claimed is:

1. An image processing apparatus comprising:
at least one memory configured to store one or more instructions; and
at least one processor configured to execute the one or more instructions to:
detect a keypoint of a human body included in an image;
compute a degree of similarity between a pose or a movement of a human body detected from the image and a pose or a movement of a human body indicated by a preregistered template image, based on the detected keypoint;
determine a place in the image where a human body with the degree of similarity to a pose or a movement of a human body indicated by any template image to be less than a first threshold value but satisfying a first similarity condition to a pose or a movement of a human body indicated by any template image is captured; and
output information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.

2. The image processing apparatus according to claim 1, wherein
the at least one processor is further configured to execute the one or more instructions to determine whether the human body detected from the image satisfies the first similarity condition, based on the detected keypoint.

3. The image processing apparatus according to claim 2, wherein
the first similarity condition includes a condition that the degree of similarity is equal to or more than a second threshold value and is less than the first threshold value.

4. The image processing apparatus according to claim 2, wherein
the first similarity condition includes a condition that the degree of similarity to a pose or a movement of a human body indicated by the template image computed based on a part of the keypoints among the plurality of keypoints detected from each human body is equal to or more than a third threshold value.

5. The image processing apparatus according to claim 2, wherein
the first similarity condition includes a condition that the degree of similarity to a pose or a movement of a human body indicated by the template image computed in consideration of a weighted value provided to each of the plurality of keypoints detected from each human body is equal to or more than a fourth threshold value.

6. The image processing apparatus according to claim 2, wherein
the image and the template image are a moving image, and a movement of a human body is indicated by a time change in a pose of a human body indicated by each of a plurality of template images included in the moving image, and
the first similarity condition includes a condition of including a plurality of frame images indicating each human body with a pose in which a degree of similarity to a pose of a human body indicated by each of frame images in a predetermined proportion or more among the plurality of frame images included in the template image is equal to or more than a fifth threshold value.

7. The image processing apparatus according to claim 1, wherein
the at least one processor is further configured to execute the one or more instructions to output information indicating the template image that satisfies the first similarity condition to a human body captured at the determined place.

8. An image processing method comprising,
by a computer:
detecting a keypoint of a human body included in an image;
computing a degree of similarity between a pose or a movement of a human body detected from the image and a pose or a movement of a human body indicated by a preregistered template image, based on the detected keypoint;
determining a place in the image where a human body with the degree of similarity to a pose or a movement of a human body indicated by any template image to be less than a first threshold value but satisfying a first similarity condition to a pose or a movement of a human body indicated by any template image is captured; and
outputting information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.

9. A non-transitory storage medium storing a program causing a computer to:
detect a keypoint of a human body included in an image;
compute a degree of similarity between a pose or a movement of a human body detected from the image and a pose or a movement of a human body indicated by a preregistered template image, based on the detected keypoint;
determine a place in the image where a human body alse with the degree of similarity to a pose or a movement of a human body indicated by any template image to be less than a first threshold value but satisfying a first similarity condition to a pose or a movement of a human body indicated by any template image is captured; and
output information indicating the determined place or a partial image acquired by cutting the place out of the image, as a candidate for the template image to be additionally registered in a decision apparatus that decides a pose or a movement of a human body detected from the image, based on a pose or a movement of a human body indicated by the template image.

10. The image processing method according to claim 8, wherein
the computer determines whether the human body detected from the image satisfies the first similarity condition, based on the detected keypoint.

11. The image processing method according to claim 10, wherein
the first similarity condition includes a condition that the degree of similarity is equal to or more than a second threshold value and is less than the first threshold value.

12. The image processing method according to claim 10, wherein
the first similarity condition includes a condition that the degree of similarity to a pose or a movement of a human body indicated by the template image computed based on a part of the keypoints among the plurality of keypoints detected from each human body is equal to or more than a third threshold value.

13. The image processing method according to claim 10, wherein
the first similarity condition includes a condition that the degree of similarity to a pose or a movement of a human body indicated by the template image computed in consideration of a weighted value provided to each of the plurality of keypoints detected from each human body is equal to or more than a fourth threshold value.

14. The image processing method according to claim 10, wherein
the image and the template image are a moving image, and a movement of a human body is indicated by a time change in a pose of a human body indicated by each of a plurality of template images included in the moving image, and
the first similarity condition includes a condition of including a plurality of frame images indicating each human body with a pose in which a degree of similarity to a pose of a human body indicated by each of frame images in a predetermined proportion or more among the plurality of frame images included in the template image is equal to or more than a fifth threshold value.

15. The image processing method according to claim 8, wherein
the computer further outputs information indicating the template image that satisfies the first similarity condition to a human body captured at the determined place.

16. The non-transitory storage medium according to claim 9, wherein
the program causing the computer to determine whether the human body detected from the image satisfies the first similarity condition, based on the detected keypoint.

17. The non-transitory storage medium according to claim 16, wherein
the first similarity condition includes a condition that the degree of similarity is equal to or more than a second threshold value and is less than the first threshold value.

18. The non-transitory storage medium according to claim 16, wherein
the first similarity condition includes a condition that the degree of similarity to a pose or a movement of a human body indicated by the template image computed based on a part of the keypoints among the plurality of keypoints detected from each human body is equal to or more than a third threshold value.

19. The non-transitory storage medium according to claim 16, wherein
the first similarity condition includes a condition that the degree of similarity to a pose or a movement of a human body indicated by the template image computed in consideration of a weighted value provided to each of the plurality of keypoints detected from each human body is equal to or more than a fourth threshold value.

20. The non-transitory storage medium according to claim 16, wherein
the image and the template image are a moving image, and a movement of a human body is indicated by a time change in a pose of a human body indicated by each of a plurality of template images included in the moving image, and
the first similarity condition includes a condition of including a plurality of frame images indicating each human body with a pose in which a degree of similarity to a pose of a human body indicated by each of frame images in a predetermined proportion or more among the plurality of frame images included in the template image is equal to or more than a fifth threshold value.
